(19) United States
(12) Patent Application Publication
(10) Pub. No.: US 2026/0258165 A1
(43) Pub. Date: Sep. 3, 2026

(54) ALPHA-OMEGA-FUNCTIONALIZED POLYMERS

(71) Applicant: ARLANXEO DEUTSCHLAND GMBH, Dormagen (DE)

(72) Inventors: Benjamin GUTSCHANK, Dormagen (DE); Thomas RUENZI, Duesseldorf (DE)

(73) Assignee: ARLANXEO DEUTSCHLAND GMBH, Dormagen (DE)

(21) Appl. No.: 18/878,344

(22) PCT Filed: Jun. 22, 2023
(86) PCT No.: PCT/EP2023/067020

§ 371 Date: Dec. 23, 2024

(30) Foreign Application Priority Data
Jun. 23, 2022 (EP) 22180713.4

(51) Int. Cl. C08F 2/60; C08F 236/06; C08F 236/14

(52) U.S. Cl. CPC C08F 2/60; C08F 236/06; C08F 236/14; C08F 2500/21

(57) ABSTRACT

A functionalized diene polymer having a first functional group and a second functional group, wherein the first functional group is a terminal group, a side croup, or a combination thereof, and
(i) comprises at least one unit of formula (1):

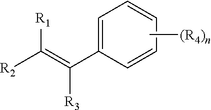

wherein R₁, R₂, R₃, R₄, and n are as defined herein; or
(ii) is obtained by using a polymerization initiator of the general formula N(R₁)(R₂)(R₃M), wherein R₁, R₂, R₃, and M are as defined herein;
wherein the second functional group is a terminal group and comprises —COOX, —OX, —SX, or any combination thereof, wherein X is as defined herein;
wherein the functionalized diene polymer is a homopolymer or a copolymer of a conjugated diene selected from butadiene, isoprene, isoprene, 1,3-pentadiene, 2,3-dimethylbutadiene, 1-phenyl-1,3-butadiene, 1,3-hexadiene. Also provided are methods for producing the polymers, articles obtained from the polymer and methods for making articles with the polymer.

### BACKGROUND

Diene rubbers are used in many different applications. They are typically combined with fillers and other additives to produce rubber compounds and then shaped into articles. The interactions of rubbers with fillers that are used in making the rubber compounds can be improved by introducing functional end groups to the polymer. Therefore, various diene rubbers with functionalized with polar end groups have been developed. Diene rubbers with polar functional groups can lead to improved compounds as described for example in US patent applications US2016/0075809 A1 and US2016/0083495 A1 and in international patent application WO2021/009154. Improved properties are also reported for polymers prepared with amino-functionalized monomers as described, for example in US2020/0277426 A1 and EP 2847264 A1. However, there is a continuous need for further diene polymers with improved properties.

### SUMMARY

Therefore, in one aspect there is provided a polymer composition comprising a functionalized diene polymer having at least one first functional group and at least one second functional group wherein the first functional group is selected from terminal groups, side groups and combinations thereof and wherein the second functional group is a terminal group, wherein the first functional group
(i) comprises at least one unit derived from a functionalizing monomer represented by formula (1)

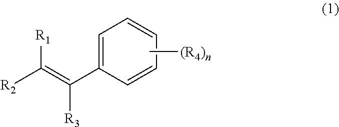

wherein R₁, R₂, R₃ are selected from hydrogen and methyl with the proviso that at least one of R₁, R₂ and R₃ is hydrogen, preferably R₁, R₂, and R₃ are all hydrogen,
n is 1, 2, 3, 4 or 5,
each R₄ is selected independently from an aliphatic, or aryl aliphatic residue having from 3 to 30 carbon atoms and wherein R₄ comprises at least one tertiary amine group if n is 1 and in case n is 2 to 5 at least one of the residues R₄ comprises at least one tertiary alkyl amine group; or
(ii) wherein the first functional group is obtained by using a polymerization initiator of the general formula N(R₁)(R₂)(R₃Li), wherein R₁ and R₂ are identical or different from each other and are selected from linear or branched saturated alkyls, R₃ is a saturated, linear or branched alkyl carbanion and M is an alkali cation,
and.
wherein the second functional group is a terminal group and comprises at least one group selected from —COOX; —OX; —SX, a plurality thereof and combinations thereof, wherein X represents hydrogen or a cation, and
wherein the functionalized diene polymer is a homopolymer or a copolymer of a conjugated diene and wherein the conjugated diene is selected from the group consisting of butadiene, isoprene, isoprene, 1,3-pentadiene, 2,3-dimethylbutadiene, 1-phenyl-1,3-butadiene, 1,3-hexadiene, preferably butadiene.

In another aspect there is provided a process of producing the above polymer comprising polymerizing at least one conjugated diene in a polymerization reaction to produce a diene polymer wherein either, (i) at least one functionalizing monomer, or an active reaction product comprising at least two repeating units derived from the functionalizing monomer, is added to the conjugated diene before, at the start or during the polymerization reaction to create a functionalized polymer having at least one first functional group comprising at least one unit derived from the functionalizing monomer, or (ii) the polymerization is started by using an initiator of the of the general formula N(R₁)(R₂)(R₃M) as described above, or a combination of (i) and (ii),
wherein the reaction further comprises adding at least one functionalizing agent to the functionalized diene polymer to create a second functional group, wherein the functionalizing monomer is represented by formula (1)

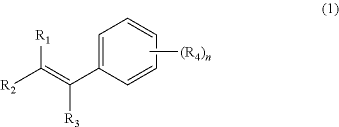

wherein R₁, R₂, R₃ are selected from hydrogen and methyl with the proviso that at least one of R₁, R₂ and R₃ is hydrogen, preferably R₁, R₂, and R₃ are all hydrogen,
n is 1, 2, 3, 4 or 5, each R₄ is selected independently from an aliphatic, or aryl aliphatic residue having from 3 to 30 carbon atoms and wherein R₄ comprises at least one tertiary amine group if n is 1 and in case n is 2 to 5 at least one of the residues R₄ comprises at least one tertiary alkyl amine group; and wherein the second functional group is a terminal group and comprises at least one group selected from —COOX; —OX; —SX, a plurality thereof or combinations thereof, wherein X represents hydrogen or a cation, and
wherein the conjugated diene is selected from the group consisting of butadiene, isoprene, isoprene, 1,3-pentadiene, 2,3-dimethylbutadiene, 1-phenyl-1,3-butadiene, 1,3-hexadiene, preferably butadiene.

In another aspect there is provided a curable rubber compound comprising the above polymer and further comprising at least one curing agent capable of curing the polymer.

In a further aspect there is provided a rubber compound comprising the above polymer in a cured form.

In yet another aspect there is provided a process of making a rubber compound comprising combining the polymer with at least one curing agent capable of curing the polymer and, optionally, subjecting the polymer to curing.

In yet a further aspect there is provided a process of making an article comprising subjecting a rubber compound comprising the polymer and at least one curing agent capable of curing the polymer to curing and shaping wherein the shaping may take place before, during or after the curing.

In another aspect there is provided an article comprising a reaction product of a curing reaction of a composition comprising the polymer, wherein the article is selected from a tire, a tire tread, a shoe sole, a golf ball, a belt or a seal.

### DETAILED DESCRIPTION

In the following description contrary to the term “consisting of”, the terms “comprising”, “containing”, “including”, “having” are not intended to exclude the presence of any additional component, step or procedure. For example, a composition referred to herein as “comprising components A and B” means other components may be present in that composition, in addition to components A and B.

The term “consisting of” is used if the presence of any additional component, step or procedure is meant to be excluded.

In the following description norms may be used. If not indicated otherwise, the norms are used in the version that was in force on Mar. 1, 2020. If no version was in force at that date because, for example, the norm has expired, the version is referred to that was in force at a date that is closest to Mar. 1, 2020.

In the following description the amounts of ingredients of a composition or polymer may be indicated interchangeably by “weight percent”, “wt. %” or “% by weight”. The terms “weight percent”, “wt. %” or “% by weight” are based on the total weight of the composition or polymer, respectively, which is 100% unless indicated otherwise.

The term “phr” means parts per hundred parts of rubber.

Ranges identified in this disclosure include and disclose all values between the endpoints of the range and include the end points unless stated otherwise.

The term “substituted” is used to describe hydrocarbon-containing organic compounds where at least one hydrogen atom has been replaced by a chemical entity other than a hydrogen. That chemical entity is referred to herein interchangeably as “substituent”, “residue” or “radical”. For example, the term “a methyl group substituted by fluorine” refers to a fluorinated methyl group and includes the groups —CF₃, —CHF₂ and —CH₂F. The term “unsubstituted” is meant to describe a hydrocarbon-containing organic compound of which none of its hydrogen atoms have been replaced. For example, the term “unsubstituted methyl residue” refers to a methyl, i.e. —CH₃.

### Diene Polymers

The diene polymers according to the present disclosure are functionalized polymers and they comprise at least two functional groups. A first functional group is derived from one or more amine-functionalized monomers. Preferably, this first functional group is situated at the beginning, i.e., at the alpha position, of the polymer chain. However, in addition or as an alternative, the first functional group may also be present as one or more side group. The diene polymers according to the present disclosure further comprise at least a second functional group. The second functional group is a terminal group and preferably is present at the opposite position of the polymer chain compared to the position of the first functional group.

The diene polymers according to the present disclosure comprise units derived from at least one conjugated diene. The diene polymers according to the present disclosure can be obtained by a polymerization reaction comprising the polymerization of at least one conjugated diene as monomer. Preferably, the diene polymer is a homopolymer or a copolymer of at least one conjugated diene, preferably selected from butadiene, isoprene, 1,3-pentadiene, 2,3-dimethyl-butadiene, 1-phenyl-1,3-butadiene, 1,3-hexadiene. Butadiene and/or isoprene are particularly preferred.

In one embodiment of the present disclosure the diene polymer is a polybutadiene homopolymer, more preferably a butadiene homopolymer. In another embodiment of the present disclosure the diene polymer is a butadiene-copolymer.

In another embodiment of the present disclosure the diene polymer is a copolymer of a conjugated diene, preferably a copolymer comprising units derived from one or more conjugated diene as described above and/or one or more vinyl aromatic monomer, and, optionally, one or more units derived from one or more other comonomers. Examples of vinylaromatic monomers include, but are not limited to, styrene, ortho-methyl styrene, meta-methyl styrene, para-methyl styrene, para-tertbutyl styrene, vinyl naphthalene, and combinations thereof. Styrene is particularly preferred. The vinylaromatic monomers also include substituted vinyl aromatic monomers where one or more hydrogen atoms of the vinyl aromatic monomer have been replaced by a heteroatom or groups having one or more heteroatoms, preferably selected from Si, N, O, H, Cl, F, Br, S and combinations thereof. Substituted monomers also include vinyl aromatic monomers having one or more functional groups with one or more heteroatoms or units containing at least one functional group with one or more heteroatom. Preferably, the heteroatoms are selected from Si, N, O, H, Cl, F, Br, S and combinations thereof. Examples of functional groups include but are not limited to hydroxy, thiol, thioether, ether, halogen carboxylic acid groups or salt thereof and combinations thereof. Such functionalized conjugated monomers are preferably copolymerized with one or more of the vinylaromatic monomers described above. In a preferred embodiment the diene polymer according to the present disclosure comprises repeating units derived from 1,3-butadiene and styrene.

Preferably, the polymers according to the present disclosure contain at least 50% by weight, preferably at least 60% by weight, based on the weight of the polymer, of units derived from 1,3-butadiene. In one embodiment of the present disclosure the diene polymers contain at least 60% by weight, or at least 75% by weight units derived from 1,3-butadiene. In one embodiment the polymer according to the present disclosure comprises at least 75% or at least 95% by weight of units derived from one or more than conjugated diene monomers.

In one embodiment of the present disclosure the diene polymers contain from 0 to 49% by weight, or from 0% to 40% by weight, based on the total weight of the polymer, of units derived from one or more comonomers.

In one embodiment the diene polymers of the present disclosure contain from 0 to 20% by weight of units derived from one or more conjugated dienes other than 1,3 butadiene.

In one embodiment the diene polymers according to the present disclosure contain at least 50% by weight, preferably at least 60% by weight, based on the weight of the polymer, of units derived from 1,3-butadiene and at least 5% by weight, and preferably up to 49% by weight, of units derived from one or more vinyl aromatic comonomer, preferably from 5% to 40% by weight, or from 10% to 35% by weight, of units derived from one or more vinyl aromatic comonomer, preferably a styrene. Optionally, such polymers may comprise from 0 to 25% by weight of one or more other comonomer with the proviso that the total amount of monomers is adjusted such that the polymer still has a total weight of 100%. In one embodiment the polymer according to the present disclosure comprises from 55% to 92% by weight of units derived from one or more conjugated diene monomers and from 5.8% to 45% by weight of units derived from vinyl aromatic comonomers.

Suitable other conjugated dienes as comonomer include but are not limited to myrcene, ocimenes and/or farnesenes. The conjugated dienes also include substituted conjugated dienes, where one or more hydrogen atoms of the diene have been replaced by groups containing one or more heteroatoms selected from Si, N, O, H, Cl, F, Br, S and combinations thereof or functional groups containing one or more heteroatoms, for example functional groups having one or more heteroatoms selected from Si, N, O, H, Cl, F, Br, S and combinations. Examples of functional groups include but are not limited to hydroxy, thiol, thioether, ether, halogen and units having one or more carboxylic acid groups or salt thereof and combinations thereof. Such functionalized conjugated dienes are preferably copolymerized with one or more of the conjugated dienes described above. Suitable copolymerizable comonomers further include one or more alpha-olefins, for example, ethene, propene, 1-butene, 1-pentene, 1-hexene, 4-methyl-1-pentene, 1-octene and combinations thereof. In one embodiment, the diene polymers according to the present disclosure contain from 0 to 20% by weight of units derived from one or more alpha-olefins.

Suitable comonomers also include, but are not limited to, one or more other co-polymerizable comonomers that introduce functional groups—other than the functional comonomers above-including cross-linking sites, branching sites, branches, or functionalized groups. In one embodiment of the present disclosure the diene polymers contain from 0% to 10% by weight or from 0% to 5% by weight of units derived from one or more of such other comonomers. Such comonomers include, for example, divinyl benzene, trivinyl benzene, divinyl naphthalene

Combinations of one or more of comonomers of the same chemical type as described above as well as combinations of one or more comonomers from different chemical types may be used. In one embodiment of the present disclosure the other comonomers described above are absent or comprise less than 10% by weight, less than 5% by weight or not more than 1% by weight.

The diene polymers according to the present disclosure preferably have an average molecular weight (number average, Mn) of 10,000 to 2,000,000 g/mol, preferably of 100,000 to 1,000,000 g/mol.

Preferably, the diene polymers according to the present disclosure have a glass transition temperature (Tg) of from about −110° C. to about +20° C., preferably of from about −110° C. to about 0° C.

Preferably, the diene polymers according to the present disclosure have a Mooney viscosity [ML 1+4 (100° C.)] of from about 10 to about 200, preferably from about 30 to about 150 Mooney units.

Preferably, the polymers have a dispersity from about 1.03 to about 3.5.

The diene polymers can be prepared by methods known in the art. Preferably the polymers can be obtained by a process comprising an anionic solution polymerization or a polymerization using one or more coordination catalysts. The polymerization may be carried out in solution or in the gas phase. Coordination catalysts include Ziegler-Natta catalysts or monometallic catalyst systems. Preferred coordination catalysts are those based on Ni, Co, Ti, Zr, Nd, V, Cr, Mo, W or Fe.

Preferably, the polymerization reaction comprises an anionic solution polymerization. Initiators for anionic solution polymerization include organometals, preferably based on alkali or alkaline earth metals. Examples include but are not limited to methyllithium, ethyllithium, isopropyllithium, n-butyllithium, sec-butyllithium, pentyllithium, n-hexyllithium, cyclohexyllithium, octyllithium, decyl-lithium, 2-(6-lithio-n-hexoxy)tetrahydropyran, 3-(tert-butyldimethylsiloxy)-1-propyllithium, phenyllithium, 4-butylphenyllithium, 1-naphthyllithium, p-toluyllithium and allyllithium compounds, derived from tertiary N-allylamines such as [1-(dimethylamino)-2-propenyl]lithium, [1-[bis(phenylmethyl)amino]-2-propenyl]lithium, [1-(diphenylamino)-2-propenyl]lithium, [1-(1-pyrrolidinyl)-2-propenyl]lithium, lithium amides of secondary amines such as lithium pyrrolidide, lithium piperidide, lithium hexamethylene imide, lithium 1-methyl imidazolidide, lithium 1-methyl piperazide, lithium morpholide, lithium dicyclohexylamide, lithium dibenzyl amide, lithium diphenyl amide. The allyllithium compounds and the lithium amides can also be prepared in situ by reacting an organolithium compound with the respective tertiary N-allylamines or with the respective secondary amines. Di- and polyfunctional organolithium compounds can also be used, for example 1,4-dilithiobutane, dilithium piperazide. Preferably n-butyllithium, sec-butyllithium or a combination thereof are used.

To create the first functional group one or more than amine-functionalized monomer is added before or at the start of the polymerization and/or during the polymerization but not at the end of the polymerization. The amine-functionalizing monomer may also be added as an active reaction product comprising at least two repeating units derived from the functionalizing monomer. Such active reaction product may be produced by a reaction of one or more amine-functionalized monomers with an organometal compound, for example an initiator for the anionic polymerization as described above, preferably an organo lithium compound, preferably an alkyl lithium and more preferably a butyllithium. The reaction may include an oligomerization of the amine-functionalized monomers, or a co-oligomerization of the amine-functionalized monomers and one or more other comonomers, for example conjugated dienes like those described above. Oligomerization or co-oligomerization may lead to oligomerized functionalizing monomers having 2 to 200 units derived from the amine-functionalized monomers. An active reaction product as referred to herein means that the monomer either has an intact carbon-carbon double bond that can participate in the polymerization reaction or a carbanion that can be participate in the polymerization reaction or both. The reaction product may be created in a separate reaction and then added to the polymerization reactor, or it may be formed in situ, for example by co-feeding the one or more amine-functionalized monomer and reaction initiator into the polymerization reaction or by first reacting initiator and amine functionalized monomer before adding the conjugated diene monomers.

The amine-functionalized monomers according to the present disclosure correspond to formula (1):

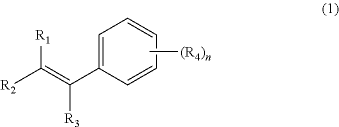

wherein R₁, R₂, R₃ are selected from hydrogen and methyl with the proviso that at least one of R₁, R₂ and R₃ is hydrogen, preferably R₁, R₂, and R₃ are all hydrogen,
n is 1, 2, 3, 4 or 5,
each R₄ is selected independently from an aliphatic, or aryl aliphatic residue having from 3 to 30 carbon atoms and wherein R₄ comprises at least one tertiary amine group if n is 1 and in case n is 2 to 5 at least one of the residues R₄ comprises at least one tertiary alkyl amine group. In one embodiment of the present disclosure R₄ is selected from a group represented by formula (2)

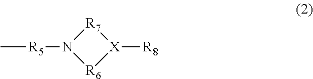

and formula (3)

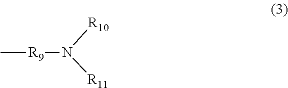

wherein in formula (2) R₅ is selected from the group consisting of a chemical bond, a linear or branched alkylene group of 1 to 20 carbon atoms unsubstituted or substituted with a substituent, a cycloalkylene group of 5 to 20 carbon atoms unsubstituted or substituted with a substituent; or an arylene group of 6 to 20 carbon atoms unsubstituted or substituted with a substituent, wherein the substituent is an alkyl group of 1 to 10 carbon atoms, a cycloalkyl group of 5 to 10 carbon atoms, or an aryl group of 6 to 20 carbon atoms, R₆ and R₇ are each independently a cycloalkyl group of 5 to 10 carbon atoms, or an alkylene group of 1 to 20 carbon atoms unsubstituted or substituted with an aryl group of 6 to 20 carbon atoms, R8 is hydrogen; an alkyl group of 1 to 30 carbon atoms; an alkenyl group of 2 to 30 carbon atoms; an alkynyl group of 2 to 30 carbon atoms; a heteroalkyl group of 1 to 30 carbon atoms; a heteroalkenyl group of 2 to 30 carbon atoms; a heteroalkynyl group of 2 to 30 carbon atoms; a cycloalkyl group of 5 to 30 carbon atoms; an aryl group of 6 to 30 carbon atoms; or a heterocyclic group of 3 to 30 carbon atoms, and X is a chemical bond or an N, O or S atom, in case where X is O or S or a chemical bond R₈ is not present,
wherein in formula (3) Re is an alkylene group of 1 to 20 carbon atoms unsubstituted or substituted with a substituent, a cycloalkylene group of 5 to 20 carbon atoms unsubstituted or substituted with a substituent; or an arylene group of 6 to 20 carbon atoms unsubstituted or substituted with a substituent, wherein the substituent is an alkyl group of 1 to 10 carbon atoms, a cycloalkyl group of 5 to 10 carbon atoms, or an aryl group of 6 to 20 carbon atoms, and R₁₁ and R₁₂ are each independently an alkyl group of 1 to 30 carbon atoms; an alkenyl group of 2 to 30 carbon atoms; an alkynyl group of 2 to 30 carbon atoms; a heteroalkyl group of 1 to 30 carbon atoms; a heteroalkenyl group of 2 to 30 carbon atoms; a heteroalkynyl group of 2 to 30 carbon atoms; a cycloalkyl group of 5 to 30 carbon atoms; an aryl group of 6 to 30 carbon atoms; or a heterocyclic group of 3 to 30 carbon atoms.

Specific examples include, but are not limited to,

### 4-(2-(N,N-bis(trimethylsilyl)amino)ethyl)styrene

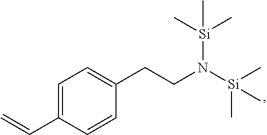 [SMILES: C=Cc1ccc(CCN([Si](C)(C)C)[Si](C)(C)C)cc1]

vinylbenzylpyrrolidine,

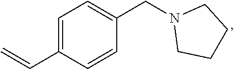

and N,N-dimethylaminomethylstyrene

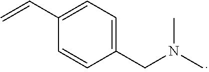

In another embodiment of the present disclosure the first functional group is obtained by using a polymerization initiator of the general formula N(R₁)(R₂)(R₃M) for starting the polymerization wherein R₁ and R₂ are identical or different from each other and are all selected from linear or branched saturated alkyls, preferably having from 2 to 18, more preferably from 3 to 12 or from 3 to 8 carbon atoms,
R₃ is a saturated alkyl carbanion which may be linear or branched and preferably is linear.

Preferably, R₃ comprises from 2 to 12, preferably from 3 to carbon atoms.

M represents a metal cation, preferably an alkali metal cation and more preferably a lithium cation, Li⁺.

In one embodiment of the present disclosure the polymerization initiator of the general formula N(R₁)(R₂)(R₃M) has at least one of R₁, R₂ and R₃ that is linear, preferably at least two of R₁, R₂ and R₃ are linear and more preferably at least all of R₁, R₂ and R₃ are linear.

In another embodiment of the present disclosure the polymerization initiator of the general formula N(R₁)(R₂)(R₃M) is branched and at least one, preferably both of R₁ and R₂ are branched. In one embodiment of the present disclosure R₃ is branched. In one embodiment R₁ and R₂ are identical or different and correspond to a residue (R₄)(R₅)(R₆)C—CH₂— wherein R₄, R₅, R₆ are selected from hydrogen, linear or branched saturated alkyl having from 1 to 14 carbon atoms, preferably 1 to 4 carbon atoms, with the proviso that not all of R₄, R₅ and R₆ are H and with the proviso that if R₄ and R₅ are both H, then R₆ is branched. Specific examples of R1 and R2 include but are not limited to n-butyl, sec-butyl, tert-butyl, n-propyl, iso-propyl, 2-methyl pentyl, 3-methyl pentyl, n-pentyl. Specific examples for R₃ include but are not limited to ethyl, methyl, n-propyl, isopropyl, n-butyl, 2-methyl-butyl, 3-methyl-butyl, 2-ethyl-butyl, 3-ethyl-butyl,

The initiators can be prepared, for example, by reacting a reacting a halogenated, preferably chlorinated tertiary linear or branched amine, preferably a mono-halogenated tertiary linear or branched amine, with an alkali metal, preferably lithium, as is known in the art. The halogenated tertiary amine corresponds to the amines described above with R₁, R₂ and R₃ having the same meaning except that residue R₃ is not an alkyl carbanion but a halogenated alkyl, preferably halogenated at a terminal position, and preferably R₃ is mono-chlorinated.

A combination of at least one amine-containing initiator as described above and at least one amino-functionalized monomer as described above may be used.

Randomizers and control agents as known in the art can be used in the polymerization for controlling the structure of the polymer. Such agents include, for example, those described in [0027] of US2016/0075809 A1, incorporated herein by reference.

Preferred solvents for the solution polymerization include inert aprotic solvents, for example aliphatic hydrocarbons. Specific examples include, but are not limited to, butanes, pentanes, hexanes, heptanes, octanes, decanes and cyclopentane, methylcyclopentane, cyclohexane, methylcyclohexane, ethylcyclohexane, 1,4-dimethylcyclohexane and combinations thereof and including isomers thereof. Further examples include alkenes such as 1-butene or aromatic hydrocarbons such as benzene, toluene, ethylbenzene, xylene, diethylbenzene or propylbenzene and combinations thereof. These solvents can be used individually or as mixtures. Preferred solvents are cyclohexane, methylcyclopentane and n-hexane. The solvents may also be mixed with polar solvents if appropriate.

The polymerization can be carried out by first introducing the monomers and the solvent and then starting the polymerization by adding the initiator or catalyst. The polymerization may also be carried out in a feed process where the polymerization reactor is filled by adding monomers and solvents. The initiator or catalyst are introduced or added with the monomers and solvent. Variations may be applied, such as introducing the solvent in the reactor, adding initiator or catalyst followed by adding the monomers. The polymerization can be carried out in a continuous mode or batchwise. Further monomer and solvent may be added during or at the end of the polymerization. The polymerization can be carried out at normal pressure or at elevated pressure (for example, from 1 to 10 bar) or at reduced pressure. Typical reaction temperatures include temperatures between 35° C. and 130° C.

In one embodiment of the present disclosure there is provided a process of producing a functionalized polydiene polymer according to the present disclosure wherein the process comprises polymerizing at least one conjugated diene in a polymerization reaction to produce a diene polymer wherein at least one functionalizing monomer (or an active reaction product comprising at least two repeating units derived from the functionalizing monomer, for example 2 to 200 units) is added to the conjugated diene before, at the start or during the polymerization reaction to create a functionalized polymer having at least one first functional group derived from the functionalizing monomer, wherein the reaction further comprises adding at least one functionalizing agent to the functionalized diene polymer to create a second functional group at the polymer chain ends wherein the second functional group comprises a carboxylic acid group or a salt thereof. Preferably, the active reaction product is a reaction product of the functionalizing monomer and reaction initiator, preferably an organolithium, more preferably a butyllithium.

The formation of the second functional groups involves at least one functionalization reaction to create a functional group comprising a polar group selected from —COOX, —OX, and —SX groups, a plurality thereof and combinations thereof, wherein X represents hydrogen or a cation. The functionalization reaction comprises the addition of at least one functionalization agent to the polymerization reaction and may be followed by the addition of the same or of at least one other functionalization reagent. For example, a first functionalization agent may be added to the polymerization and the same or a second functionalization agent may be added simultaneously, or subsequently to the reaction product of the first functionalization reagent with the reactive polymer chain. The addition of the first or second functionalization agent can be part of a continuous polymerization process or part of a batch process. Therefore, the diene polymer according to the present disclosure is functionalized by one or more appropriate functionalization agent to create a second functional group, preferably a terminal group at the opposite end of the polymer chain compared to the location of the first functional group. The second functional group comprises at least one polar unit selected from the groups —COOX groups; —OX groups; —SX groups, a plurality thereof and combinations thereof, wherein X represents hydrogen or a cation. The cation may be organic or inorganic. Examples of suitable cations include but are not limited to Li, Na, K, Mg, Ca, Zn, Fe, Co, Ni, Al, Nd, Gd, Ti, Sn, Si, Zr, V, Mo or W and preferably include Li, Na, K, Mg and Ca. It is believed that the polar groups introduced by the functionalizing monomer positively interact with the polar groups of the second functional groups introduced by the functionalizing agent.

Preferably, the second functional group that further comprises at least one silyl, one silane or siloxane unit. Preferably, the second functional group comprises from 1 to 20 silicon atoms in addition to carbon and hydrogen atoms, and optional oxygen atoms. Preferably, the second functional group comprises from 1 to 150 carbon atoms.

Preferably, the second functional group comprises at least one group selected from the formulae —Si(R¹)(R²)—C(R³)(R⁴)—, —Si(R¹)(R²)—O—Si(R³)(R⁴)— or a combination thereof wherein R¹, R², R³, R⁴ are identical or different and are selected from H, and C₁-C₁₂ alkyl groups that, optionally, comprise heteroatoms selected from O, N, S, and Si, for example as alkoxy groups, trialkyl silyl groups, alkyl amino groups, dialkyl amino groups, trialkylsilyl amino groups and combinations thereof. Preferably these groups are linked via the silicone atom to the polymer chain.

Preferably, the second functional group further comprises one or more heterogroups selected from (i) a thioether group, (ii) amino groups —N(R₁)—, —N(R₁)(R₂)— or —N(R₁)(R₂)(R₃), wherein R₁, R₂ and R₃ are independently selected from H, C₁-C₆ alkyl and —Si(C₁-C₆ alkyl)₃ with the proviso that not all of R₁, R₂ and R₃ represent H, (iii) ether groups —OR₄ or —OR₅—, wherein R₄ is a C₁-C₆ alkyl and R₅ is a C₁-C₆ alkylene, or a plurality or combination of such heterogroups.

In one embodiment the second functional group comprises at least one silyl, silanol or siloxane group selected from: —SiH₂(OH), —SiR₂(OH), —SiH(OH)₂, —SiR₁(OH)₂, —Si(OH)₃, —Si(OR₁)S, —(SiR₁R₂O)ₓ—R₃, —Si(R₃)₃₋ₘ(X)ₘ, where X is a halogen, x is the number of repetitive units between 1 and 30, m is the number of linked groups, varying from 0 to 3, R₁ and R₂ are identical or different, and can be alkoxy or alkyl, linear or branched, cycloalkyl, aryl, alkylaryl, aralkyl or vinyl groups, in each case having 1 to 20 carbon atoms, and R₃ is H or alkyl, linear or branched, in each case having 1 to 20 carbon atoms, or a mononuclear aryl group.

In one embodiment the second functional group comprises or consists of a group represented by the formula

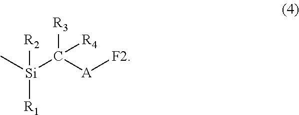

where R₁ and R₂ are identical or different, and can be alkoxy or alkyl, linear or branched, cycloalkyl, aryl, alkylaryl, aralkyl or vinyl groups, in each case having 1 to 20 carbon atoms, and n represents the number of units of the siloxane functional group before a silanol terminal group, varying from 1 to 49, preferably 1 to 29.

In one embodiment of the present disclosure the second functional group consists or comprises of a polar unit represented by formula (4):

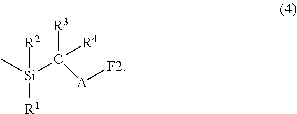

In formula (4) R¹, R² are the same or different and are each selected from H or an organic residue selected from alkyl, cycloalkyl, aryl, alkylaryl, arylalkyl groups having from 1 to 20 carbon atoms and which may, optionally contain one or more oxygen atom in the carbon chain, or at the beginning of the chain connected to the Si atom, or in the carbon-carbon ring in case of a cyclic residue. In case R¹ or R² represents an alkoxy residue with the oxygen atoms linked to the Si atom, preferably, either R¹ or R² but not both represent an alkoxy residue. R¹ and R², optionally, may also contain, independently from each other, one or more substituents selected from alkyl amino, dialkyl amino, alkyl phosphino, alkyl silyl, alkylsilylamino groups and combinations thereof.

In formula (4) R³, R⁴ each selected from H or an organic residue selected from alkyl, cycloalkyl, aryl, alkylaryl, arylalkyl groups having from 1 to 20 carbon atoms and which may, optionally contain one or more oxygen atom in the carbon chain or carbon ring. R³ and R⁴, optionally, may also contain, independently from each other, one or more substituents selected from alkyl amino, dialkyl amino, alkyl phosphino, alkyl silyl, alkylsilylamino groups and combinations thereof.

In formula (4) A represents a divalent organic, aliphatic, aromatic or aliphatic and aromatic residue having from 1 to 26 carbon atoms and wherein the residue may comprise in addition to hydrogen atoms heteroatoms selected from O, N, S, and Si. Preferably, A represents a group

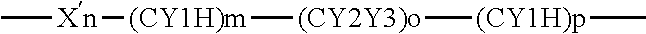

where
n is 1 or 0, m is 1, 2, 3 or 4, o is 0, 1 or 2, p is 0, 1 or 2,
X′ represents 0, S, NR, where R is H or C₁-C₃ alkyl or X′ is N(Si(alkyl)₃), wherein each “alkyl” independently from each other represents a C1-C₆ alkyl, -oxyalkyl or alkoxy;
Y1 is H or C1-C₃ alkyl, Y2 is H or C1-C₃ alkyl, Y3 is H or C1-C₃ alkyl, preferably at least one of Y2 and Y3 is H.

Specific, non-limiting-examples of A include:
—CH₂—; —CH₂CH₂—; —CH₂CH₂CH₂—; —C(CH₃)—CH₂—; —CH₂—C(CH₃)—CH—; —CH(CH₃)—C(CH₃)H—; —CH(CH₃)—CH₂—C(CH₃)H—; —CH₂—C(CH₃)H—C(CH₃)H—; —CH(CH₃)—C(CH₃)H—CH₂—; —O—CH₂—; —O—CH₂CH₂—; —O—CH₂CH₂—CH₂—; —O—C(CH₃)H—; —O—CH₂CH₂—; —O—C(CH₃)H—CH₂—; —O—CH₂—C(CH₃)H—; —O—CH₂—C(CH₃)H—CH₂—; —O—CH₂CH₂—C(CH₃)H—; —O—C(CH₃)H—CH₂—CH₂—; —S—CH₂—; —S—CH₂CH₂—; —S—CH₂CH₂—CH₂—; —S—C(CH₃)H—; —S—CH₂CH₂—; —S—C(CH₃)H—CH₂—; —S—CH₂—C(CH₃)H—; —S—CH₂—C(CH₃)H—CH₂—; —S—CH₂CH₂—C(CH₃)H—; —S—C(CH₃)H—CH₂—CH₂—;
—NH—CH₂—; —NH—CH₂CH₂—; —NH—CH₂CH₂—CH₂—; —NH—C(CH₃)H—CH₂—; —NH—CH₂—C(CH₃)H—; —NH—CH₂—C(CH₃)H—CH₂—; —NH—CH₂CH₂—C(CH₃)H—; —NH—C(CH₃)H—CH₂—CH₂—; —N(CH₃)—CH₂—; —N(CH₃)—CH₂—; —N(CH₃)—CH₂CH₂—; —N(CH₃)—CH₂CH₂—CH₂—; —N(CH₃)—C(CH₃)H—CH₂—; —N(CH₃)—CH₂—C(CH₃)H—; —N(CH₃)—CH₂—C(CH₃)H—CH₂—; —N(CH₃)—CH₂CH₂—C(CH₃)H—; —N(CH₃)—C(CH₃)H—CH₂—CH₂—; N(Si(alkyl)₃)—CH₂—; —N(Si(alkyl)₃)—CH₂CH₂—; N(Si(alkyl)₃)—CH₂CH₂CH₂—; —N(Si(alkyl)₃)—C(CH₃)H—; —N(Si(alkyl)₃)—CH₂CH₂—; —N(Si(alkyl)₃)—C(CH₃)H—CH₂—; —N(Si(alkyl)₃)—CH₂—C(CH₃)H—; —N(Si(alkyl)₃)—CH₂—C(CH₃)H—CH₂—; —N(Si(alkyl)₃)—CH₂CH₂—C(CH₃)H—; —N(Si(alkyl)₃)—C(CH₃)H—CH₂—CH₂—.

In formula (4) F2 represents —COOX or —OX and X represents hydrogen, an organic cation or an inorganic cation.

In one embodiment of the present disclosure the second functional group consists or comprises of a polar unit represented by formula (5):

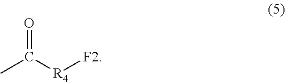

In formula (5) R₄ represents a residue connecting the carbonyl group and the F2 group. R₄ represents a residue comprising a C₁-C₃-alkylene group. Preferably, R₄ is selected from a C1-C₃-alkylene group that may be saturated or unsaturated and that may be unsubstituted or substituted by one or more than one substituent, preferably, selected from a saturated or unsaturated C₁-C₁₃-alkyl wherein the alkyl may be substituted by one or more groups selected from alkoxy groups and oxyalkyl groups having from 1 to 6 carbon atoms and —SiO(Rx)₃ groups wherein each Rx represents independently an alkyl with 1 to 6 carbon atoms. Preferably R₄ is an unsubstituted C₁-C₃-alkylene, for example —CH₂— or —CH₂CH₂—. In formula (5) F2 has the same meaning as in formula 4.

The second functional groups can be generated as known in the art, for example as described in U.S. Pat. No. 3,242,129 or U.S. Pat. Nos. 4,020,036, 4,465,809, US patent applications US2016/0075809 A1 and US2016/0083495, WO2021/009154 and US2013/0281605.

In one embodiment of the present disclosure the second functional group is obtained by at least one functionalization reaction comprising the use of at least one silicon-containing compound as functionalization agent. If necessary, the reaction product is treated with a suitable reagent to obtain at least one terminal unit selected from —OX, —COOX, —SX or a combination thereof, wherein X represents H or a cation. Such suitable agents may include steam, water, a polar agent including alcohols or acids. The silicone-containing compound, also referred to herein as “silicic compound”, preferably has 1 to 12 silicone atoms. The silicon-containing compound preferably is selected from a divalent compound having one Si atom per molecule or a divalent compound being an open chain siloxane having 2 to 12 silicon atoms per molecule, or a cyclic siloxane having 3 to 12 silicon atoms per molecule, or a combination thereof. The remaining valences of said silicon atoms preferably are attached to an R radical wherein each R radical is selected independently from the group consisting of hydrogen, alkyl cycloalkyl, aryl aralkyl, alkaryl radicals having up to 20 carbon atoms wherein the radicals may, optionally, heterogroups connected to the carbon chain or the carbon ring selected from alkylamines and silylamines. Silicon-containing compounds include the cyclosiloxanes, according to the formula (6):

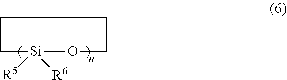

where R⁵ and R⁶ are the same or different and are each selected from H, a residue having from 1 to 20 carbon atoms, preferably selected from alkyl, cycloalkyl, aryl, alkaryl or aralkyl radical, wherein the radical may contain one or more heteroatoms, preferably O, N, S or Si, and preferably are selected from methyl. Specific examples include but are not limited to hexamethylcyclotrisiloxane, octamethylcyclotetrasiloxane, decamethylcyclopentasiloxane and dodecamethylcyclohexasiloxane, and mixtures of cyclosiloxanes of different ring sizes.

Other suitable silicic compounds include cyclic siloxanes represented by formula (7):

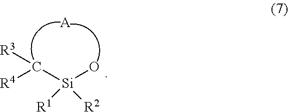

In formula (7) R¹, R², R³, R⁴ and A are as described above with regard to formula (4).

Other suitable silicone-containing compounds include silalactones which, in addition to carbon and hydrogen atoms, may comprise heteroatoms selected from Si, S, O and N, preferably in the ring structure. Suitable silalactones include those corresponding to the general formula (8):

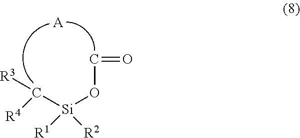

wherein in formula (8) R¹, R² R³, R⁴ and A are as described above with regard to formula (4).

In another embodiment of the present disclosure the silicic compound is selected from a thiasiloxane, for example a thiasiloxane according to the formula

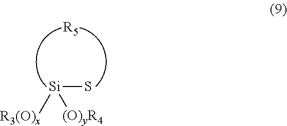

wherein in formula (9) R₃ and R₄ are the same as R¹ and R² as described above for formula (4) and x and y are selected independently from each other and either represent 0 or 1 and, preferably, the sum of x+y is either 1 or 2. In formula (9) R5 is the same as A in formula (4) described above.

The cyclicsiloxanes, silalactones and thiasiloxanes, may be added directly to reactive polymer chain ends or to the reaction product of reactive polymer chain ends and with the same or a different silicic compound. Preferably, they are added to a reaction product of reactive polymer chain ends with cyclic siloxane, preferably according to formula (6), or an open chain equivalent thereof.

In one embodiment of the present disclosure the second functional group is obtained by at least one functionalization reaction comprising the use of a cyclic anhydride, a lactone or a combination thereof as functionalization agent. Suitable anhydrides or lactones include but are not limited to those represented by general formula (10)

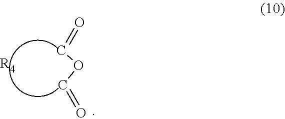

In formula (10) R₄ represents a residue comprising a C₁-C₃-alkylene group. Preferably, R₄ is selected from a C₁-C₃-alkylene group that may be saturated or unsaturated and that may be unsubstituted or substituted by one or more than one substituent, preferably, selected from a saturated or unsaturated C₁-C₁₈-alkyl wherein the alkyl may be substituted by one or more groups selected from alkoxy groups and oxyalkyl groups having from 1 to 6 carbon atoms and —SiO(Rx)₃ groups wherein each Rx represents independently an alkyl with 1 to 6 carbon atoms. Preferably R₄ is an unsubstituted C₁-C₃-alkylene, for example —CH₂— or —CH₂CH₂—.

Suitable lactones include those corresponding to formula (11):

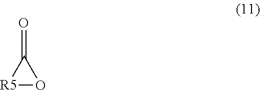

wherein R5 is the same as R4 described in formula (10).

The lactones and anhydrides are preferably added simultaneously with or subsequently to the addition of at least one other functionalizing agent to the polymer chain. Preferably, the other functionalization agent is a silicic compound as described above and more preferably a cyclic siloxane as described above or a linear or branched equivalent thereof.

The functionalized polymers according to the present disclosure may be provided as such or as oil-extended polymers. The diene polymer may be oil-extended and may contain up to 100 parts per 100 parts of polymer of extender oil. In one embodiment of the present disclosure there is provided a polymer composition comprising at least 90% by weight, preferably at least 95% by weight of the diene polymer and extender oil and preferably the weight ratio of diene polymer to extender oil is from 1:1 to 10:1. Extender oils include oils as known and used for the oil-extension of diene rubbers and include oils such as TDAE (Treated Distillate Aromatic Extract)-, MES (Mild Extraction Solvates)-, RAE (Residual Aromatic Extract)-, TRAE (Treated Residual Aromatic Extract)-, naphthenic oil, paraffinic oils and hydrogenated versions thereof including oils obtained from plant-based materials including terpenes. They are preferably added to the reaction mixture prior or during solvent removal. In one embodiment of the present disclosure the polymer is not oil-extended.

### Rubber Compounds

The diene polymers according to the present disclosure can be used to make rubber compounds by a process comprising combining at least one polymer composition with one or more filler and/or one or more curing agent for cross-linking at least the diene polymer. The rubber compounds are suitable for making articles, typically by a process comprising vulcanizing (curing) the rubber compound or a composition comprising the curable rubber compound. The resulting article typically contains the rubber compound in vulcanized form.

Therefore, in one aspect of the present disclosure there is provided a process of making a rubber compound comprising combining a polymer according to the present disclosure with at least one filler, at least one curing agent capable of curing the at least diene polymer or a combination thereof and, optionally, one or more rubber additives, and/or one or more additional rubbers other than the diene polymers according to the present disclosure.

The one or more filler and include both active and inactive fillers. Conventional fillers include silicas and, preferably, one or more than one carbon-based fillers, for example carbon blacks. Specific examples of suitable fillers are described in US2016/0075809 A1 in [0061] to [0074], incorporated herein by reference. Preferably, the rubber compounds of the present disclosure contain one or more carbon blacks as fillers. The fillers can be used alone or in a mixture. In a particularly preferred form, the rubber compositions contain a mixture of silica fillers, such as highly dispersed silicas, and carbon black. The weight ratio of silica fillers to carbon black may be from 0.01:1 to 50:1, preferably from 0.05:1 to 20:1. The fillers may be used in quantities ranging from 10 to 500, preferably from 20 to 200 parts by weight based on 100 parts by weight of rubber.

Crosslinking agents include sulfur and sulfur-supplying compounds. Typical amounts of cross-linking agents include 0.1 to 10 party by weight per 100 parts by weight of rubber.

Additional rubbers include, for example, natural rubber and synthetic rubbers. If present, they may be used in amounts in the range from 0.5 to 95% by weight, preferably in the range from 10 to 80% by weight, based on the total amount of rubber in the composition. Examples of suitable synthetic rubbers include those described in US2016/0075809 A1 in [0060], incorporated herein by reference. Specific examples include high cis-polybutadienes and linear or branched low cis polybutadienes, for example those available from ARLANXEO Deutschland GmbH.

Rubber additives are ingredients that may improve the processing properties of the rubber compositions, serve to crosslink the rubber compositions, improve the physical properties of the vulcanizates produced from the rubber, improve the interaction between the rubber and the filler or serve to bond the rubber to the filler. Rubber auxiliaries include reaction accelerators, antioxidants, heat stabilizers, light stabilizers, ozone stabilizers, processing aids, plasticizers, tackifiers, blowing agents, dyes, pigments, waxes, extenders, organic acids, silanes, retarders, metal oxides and extender oils such as DAE (Distillate Aromatic Extract)-, TDAE (Treated Distillate Aromatic Extract)-, MES (Mild Extraction Solvates)-, RAE (Residual Aromatic Extract)-, TRAE (Treated Residual Aromatic Extract)-, naphthenic and heavy naphthenic oils. Typically, vulcanization accelerators are used in amounts of 0.1 to 5 party by weight based on 100 parts by weight of rubber. The total amount of rubber additives may range from 1 to 300 parts by weight, preferably from 5 to 150 parts by weight based on 100 parts by weight of total rubber in the composition.

The rubber compositions can be prepared with conventional processing equipment for making and processing of (vulcanizable) rubber compounds and include rollers, kneaders, internal mixers or mixing extruders. The rubber compositions can be produced in a single-stage or a multi-stage process, with 2 to 3 mixing stages being preferred. Cross-linking agents, for example sulfur, and accelerators may be added in a separate mixing stage, for example on a roller, with temperatures in the range of 30° C. to 90° C. being preferred. Cross-linking agent, for example sulfur, and accelerator are preferably added in the final mixing stage.

Examples of typical formulations of rubber compounds include those shown in US2016/0075809 A1 and US2016/0083495 A1 (Steinhauser and Gross) and in international patent application WO2021/009154 (Steinhauser).

### Applications

The polymers according to the present disclosure can be used for producing rubber compounds and rubber vulcanizates, preferably for producing tires or tire treads. Rubber compounds containing the polymers provided herein are also suitable for the manufacture of molded articles, for example for the manufacture of cable sheaths, hoses, drive belts, conveyor belts, roll linings, shoe soles, sealing rings and damping elements.

Therefore, in one aspect there is provided an article obtained from curing a composition comprising the rubber compound according to the present disclosure. Another aspect of the present disclosure relates to a molded article, in particular a tire or a tire tread, comprising a vulcanized rubber composition obtained by vulcanizing the vulcanizable rubber compound according to the present disclosure.

The following examples are provided to further illustrate the present disclosure without, however, intending to limit the disclosure to the embodiments set forth in these examples.

### Methods

### Polymer Data:

The number-average molecular weight Mn, the weight-averaged molecular weight (Mw), the polydispersity D=Mw/Mn, also referred to as “PDI” were determined using gel permeation chromatography (GPC) at 35° C. (polystyrene calibration).

The Mooney viscosity was measured according to DIN ISO 289-1 (2018) at the measuring conditions ML(1+4) at 100° C.

The comonomer content can be determined by FTIR spectroscopy on rubber films. The content of vinyl, cis and trans units in the polymer can be determined by FT-IR spectrometry using the absorbances and absorbance ratios as described in the standard ISO 12965:2000(E).

The glass transition temperature (Tg) can be determined using DSC from the 2^{nd} heating curve at a heating rate of 20 K/min.

### Compound Properties

The loss factors tan δ were measured at 0° C. and at 60° C. to determine the temperature-dependent dynamic-mechanical properties. An EPLEXOR device (Eplexor 500 N) from GABO was used for this purpose. The measurements were carried out in accordance with DIN 53513 at 10 Hz on Ares strips in the temperature range from −100° C. to 100° C. Rebound resilience at 60° C. was determined according to DIN 53512.

Elastic properties were determined according to DIN53513-1990. An elastomer test system (MTS Systems GmbH, 831 Elastomer Test System) was used. The measurements were carried out in double shear mode with no static pre-strain in shear direction and oscillation around 0 on cylindrical samples (two samples each 20×6 mm, pre-compressed to 5 mm thickness) and a measurement frequency of 10 Hz in the strain range from 0.1 to 40%. The method was used to obtain the following properties:
G′ (0.5%): dynamic modulus at 0.5% amplitude sweep, G′ (15%): dynamic modulus at 15% amplitude sweep, G′ (0.5%)−G′ (15%): difference of dynamic modulus at 0.5% relative to 15% amplitude sweep, tan δ (max): maximum loss factor (G″/G′) of entire measuring range at 60° C. The difference of G′ (0.5%)−G′ (15%) is an indication of the Payne effect of the mixture. The lower the value the better the distribution of the filler in the mixture, the better the rubber-filler interaction.

### EXAMPLES

### Comparative Example 1 (Non-Functionalized Reference Polymer); C1

A moisture-free and nitrogen-flushed 20 L reactor was charged with 8500 g hexane, 1185 g butadiene, 315 g styrene and 5.43 mmol DTHFP (ditetrahydrofurylpropane). The reaction mixture was heated to 33° C. and adiabatic polymerization was initiated by adding 9.8 mmol butyl lithium and the reaction was run for 60 min (Tmax was 60.8° C.). The reaction was terminated by adding 10 mmol 1-octanol and stabilized with 4.5 g IRGANOX 1520. The solvent was removed by steam-stripping and the polymer was dried at 60° C. under reduced pressure.

### Comparative Example 2 (Reference Polymer Functionalized with End Group Comprising a Carboxylic Acid Group in Omega Position); C2

The reaction of example 1 was repeated except that after the polymerization was run for 60 min 12 mmol of octamethylcyclotetrasiloxane was added and reacted with the living polymer for 10 min at 60° C. (Tmax was 60.8° C.). Subsequently, 12 mmol 2,2-dimethyl-1-oxa-4-thia-silacyclohexan-5-one was added and reacted for 30 min at 60° C. The reaction was terminated and worked up as described in comparative example 1.

### Comparative Example 3 (Reference Polymer Functionalized with Amine-Monomer (VP) in Alpha Position); C3

A moisture-free and nitrogen-flushed 20 L reactorwas charged with 8500 g hexane, 5.43 mmol DTHFP and 25 mmol 1-(4-vinylbenzyl)pyrrolidine (VP). The reaction mixture was heated to 33° C. and 11.1 mmol butyl lithium was added and reacted for 10 min. A mixture of 1185 g butadiene and 315 g styrene was added and polymerized under adiabatic conditions for 60 min (Tmax was 60.8° C.). The reaction was terminated and worked up as described in comparative example 1.

### Example Ex01 (Functionalized Polymer with Aminomonomer (VP) in Alpha Position and with Alcohol Comprising End Group); Ex01

Comparative example 3 was repeated except that after the polymerization was carried out for 60 minutes 11.3 mmol of 2,2,4-trimethyl-[142]-oxaazasilanane was added and reacted for 30 min at 60° C. The reaction mixture was worked up as described in comparative example 1.

### Comparative Example 4 (Polymer Alpha-Functionalized with DMAMS); C4

Comparative example 3 was repeated except that a different functionalizing monomer was used (25 mmol N,N-dimethylaminomethylstyrene, DMAMS).

### Example Ex02 (Polymer Alpha-Functionalized with DMAMS and Omega Functionalized with Alcohol Comprising End Group); Ex02

Comparative example 4 was repeated except that after 60 min of polymerization 11.3 mmol of 2,2,4-trimethyl-[142]-oxaazasilanane was added and reacted for 30 min at 60° C. The reaction mixture was worked up as described in comparative example 1.

### Comparative Example 5; (Polymer Alpha-Functionalized with TSAES; C5

A moisture-free and nitrogen-flushed 20 L reactorwas charged with 8500 g hexane, 5.43 mmol DTHFP and 24 mmol 4-(2-[N,N-bis(trimethylsilyl]ethyl)styrene (TSAES). The reaction mixture was heated to 33° C. and 12.1 mmol butyl lithium was added and reacted for 60 min. A mixture of 1185 g butadiene and 315 g styrene was added and polymerized under adiabatic conditions for 60 min (Tmax was 59.0° C.). The reaction was terminated and worked up as described in comparative example 1.

### Example 1 (Functionalized Polymer with Aminomonomer (VP) in Alpha Position and a Functional Group Comprising a Carboxy Group in Omega Position with); Ex1

Comparative example 3 was repeated except that after the polymerization was carried out for 60 minutes 12 mmol of octamethylcyclotetrasiloxane was added and reacted with the living polymer for 10 min at 60° C. (Tmax was 60.8° C.). Subsequently, 12 mmol 2,2-dimethyl-1-oxa-4-thia-silacyclohexan-5-one was added and reacted for 30 min at 60° C. The reaction was terminated and worked up as described in comparative example 1.

### Example 2 (Functionalized Polymer with Aminomonomer (DMAMS) in Alpha Position and with a Functional Group Comprising a Carboxy Group in Omega Position); Ex2

Comparative example 4 was repeated except that after the polymerization was carried out for 60 minutes 12 mmol of octamethylcyclotetrasiloxane was added and reacted with the living polymer for 10 min at 60° C. (Tmax was 60.8° C.). Subsequently, 12 mmol 2,2-dimethyl-1-oxa-4-thia-silacyclohexan-5-one was added and reacted for 30 min at 60° C. The reaction was terminated and worked up as described in comparative example 1.

### Example 3 (Functionalized Polymer with Aminomonomer (TSAES) in Alpha Position and with a Functional Group Comprising a Carboxy Group in Omega Position; Ex3

Comparative example C4 was repeated except that after 60 minutes of reaction it was functionalized to have a carboxylic acid end group as described in Example 1 and worked up as described in comparative example 1.

Compounds were prepared in essence as described in US2016/0083495 A1, incorporated herein by reference. The properties of the compounds are shown in table 1.

TABLE 1

| | tan | tan | Δ | | MV | MV | Δ |
|---|---|---|---|---|---|---|---|
| | δ(0° C.) | δ(60° C.) | tan δ | Δrebound | (Polymer) | (Compound) | MV |
| C1 (no end group) | 100 | 100 | 100 | 100 | 56 | 45 | 1.24 |
| C2 (COOH end group) | 101 | 124 | 124 | 110 | 90 | 77 | 1.17 |
| C3 (αVP) | 104 | 122 | 126 | 101 | 45 | 64 | 0.70 |
| Ex01 (αVP-ωOH) | 105 | 129 | 136 | 95 | 78 | 77 | 1.01 |
| C4 (αDMAMS) | 106 | 120 | 127 | 108 | 48 | 61 | 0.79 |
| Ex02 (αDMAMS-ωOH) | 104 | 125 | 131 | 103 | 40 | 73 | 0.55 |
| C5 (αTSAES | 107 | 106 | 113 | 112 | 41 | 85 | 0.48 |
| Ex 1 (αVP-ωCOOH) | 107 | 135 | 145 | 109 | 78 | 77 | 1.01 |
| Ex 2 (αDMAMS-ωCOOH) | 108 | 138 | 149 | 107 | 79 | 74 | 1.07 |
| Ex3 (αTSAES-ωCOOH) | 108 | 124 | 133 | 113 | 141 | 68 | 2.07 |

Δ tan δ = tan δ(0° C.)/tan δ(60° C.);
Δrebound = rebound (60° C.)/rebound (23° C.)
MV (polymer) = Mooney viscosity of polymer ML 1 + 4 at 100° C. [Mooney units]
MV (compound) = Mooney viscosity of compound ML 1 + 4 at 100° C. [Mooney units]
ΔMV = MV (polymer)/MV (compound)
The values for tan δ and rebound in table 1 are referenced against the values obtained with the reference polymer of C1 and indicate the change with respect to the values obtained with C1. The corresponding values of C1 were set as 100.

A comparison of ExO1 with 03 and Ex02 with 04 shows improved tan δ values for polymers that were alpha-amino-functionalized and omega-functionalized with a hydroxy containing functional group compared to counterparts that were only alpha-functionalized.

A comparison of Ex1 with Ex01 and Ex2 with Ex02 shows that the performance of the alpha-omega-functionalized polymers can be increased further by replacing the omega hydroxy-functional group with an omega carboxy-functional group.

### Examples 4-7

α-ω-functionalized styrene-butadiene polymers as described in examples 1-3 were prepared but with different amino-containing initiators for producing α-ω-polymers with different α-groups (examples 4-6) or with no amino-containing initiator to produce only the on-polymer (comparative example 7). In example 4 a Li-tertiary amine initiator was used (di-n-butylaminopropyl lithium). In example 5 (comparative example) a Li-secondary amine initiator was used (a mixture of lithium hexamethyleneimine and lithium pyrrolidine). In example 6 the amino-functionalized monomer DMAMS was used. In example 7 (comparative, the same polymer was produced with butyllithium as initiator instead of an amino-containing initiator and the polymer was not α-functionalized. The polymers were compounded and cured. The compound recipes are shown in table 2 and compound properties are shown in table 3. As can be seen from table 3, the compound Mooney values of polymers with α-amino groups according to the present disclosure were lower than obtained with secondary amine initiators (comparative example 5). This means the compounds is easier to process. The Payne-effect was greater (lower values) for polymers with α-groups according to the present disclosure compared to comparative example 5 and 7, indicating better filler dispersion. All compounds had similar rebound values (43% at 23° C. and between 63% and 64% at 60° C.) and shore A hardness values (between 60 and 63). Mooney scorch results improved over comparative examples 5 and 7.

TABLE 2
compound recipes:

| Polymer | Example 4 | Example 5 | Example 6 | Example 7 |
|---|---|---|---|---|
| Example 4 | 70 | | | |
| Example 5 | | 70 | | |
| Example 6 | | | 70 | |
| Example 7 | | | | 70 |
| BUNA CB24 | 30 | 30 | 30 | 30 |
| ULTRASIL 7000GR | 90 | 90 | 90 | 90 |
| Carbon Black | 5 | 5 | 5 | 5 |
| VIVATEC 500 | 31 | 31 | 31 | 31 |
| AFLUX 37 | 3 | 3 | 3 | 3 |
| PALMERA A9818 | 1 | 1 | 1 | 1 |
| VULKANOX 4020LG | 2 | 2 | 2 | 2 |
| VULKANOX HS/LG | 2 | 2 | 2 | 2 |
| ANTILUX 654 | 2 | 2 | 2 | 2 |
| SI 69 | 7.2 | 7.2 | 7.2 | 7.2 |
| Sulfur | 1.7 | 1.7 | 1.7 | 1.7 |
| RHENOGRAN ZNO-80 | 3.75 | 3.75 | 3.75 | 3.75 |
| RHENOGRAN DPG-80 | 2.5 | 2.5 | 2.5 | 2.5 |

TABLE 3
Properties of compounds:

| | G′ (0.5%)- | Abrasion | MV | MV |
|---|---|---|---|---|
| | G′ (15%) | mm³ | (Polymer) | (Compound) |
| Example 4 | 0.7 | 75 | 44 | 88 |
| Example 5 | 0.8 | 76 | 77 | 106 |
| (comparative) | | | | |
| Example 6 | 0.7 | 77 | 77 | 89 |
| Example 7 | 0.9 | 79 | 73 | 84 |
| (comparative) | | | | |

1. A functionalized diene polymer having at least one first functional group and at least one second functional group wherein the first functional group is selected from terminal groups, side groups and combinations thereof and wherein the second functional group is a terminal group,
wherein the first functional group
(i) comprises at least one unit derived from a functionalizing monomer represented by formula (1) 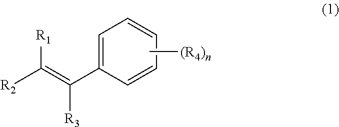
wherein R₁, R₂, R₃ are selected from hydrogen and methyl with the proviso that at least one of R₁, R₂ and R₃ is hydrogen,
n is 1, 2, 3, 4 or 5,
each R₄ is selected independently from an aliphatic, or aryl aliphatic residue having from 3 to 30 carbon atoms and wherein R₄ comprises at least one tertiary amine group if n is 1 and in case n is 2 to 5 at least one of the residues R₄ comprises at least one tertiary alkyl amine group; or
(ii) wherein the first functional group is obtained by using a polymerization initiator of the general formula N(R₁)(R₂)(R₃M), wherein R₁ and R₂ are identical or different from each other selected from linear or branched saturated alkyls and R₃ is a saturated, linear or branched alkyl carbanion and M is an alkali cation,
and
wherein the second functional group is a terminal group and comprises at least one group selected from —COOX; —OX; —SX, a plurality thereof and combinations thereof, wherein X represents hydrogen or a cation, and
wherein the functionalized diene polymer is a homopolymer or a copolymer of a conjugated diene and wherein the conjugated diene is selected from the group consisting of butadiene, isoprene, isoprene, 1,3-pentadiene, 2,3-dimethylbutadiene, 1-phenyl-1,3-butadiene, 1,3-hexadiene.

2. The polymer of claim 1 wherein in formula (1) R₄ is selected from a group represented by formula (2) 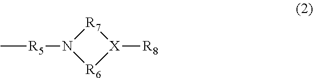
and formula (3) 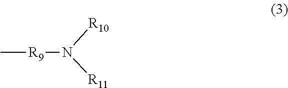
wherein in formula (2) R₅ is selected from the group consisting of a chemical bond, a linear or branched alkylene group of 1 to 20 carbon atoms unsubstituted or substituted with a substituent, a cycloalkylene group of 5 to 20 carbon atoms unsubstituted or substituted with a substituent; or an arylene group of 6 to 20 carbon atoms unsubstituted or substituted with a substituent, wherein the substituent is an alkyl group of 1 to 10 carbon atoms, a cycloalkyl group of 5 to 10 carbon atoms, or an aryl group of 6 to 20 carbon atoms, R₆ and R₇ are each independently a cycloalkyl group of 5 to 10 carbon atoms, or an alkylene group of 1 to 20 carbon atoms unsubstituted or substituted with an aryl group of 6 to 20 carbon atoms, R₈ is hydrogen; an alkyl group of 1 to 30 carbon atoms; an alkenyl group of 2 to 30 carbon atoms: an alkynyl group of 2 to 30 carbon atoms; a heteroalkyl group of 1 to 30 carbon atoms; a heteroalkenyl group of 2 to 30 carbon atoms; a heteroalkynyl group of 2 to 30 carbon atoms; a cycloalkyl group of 5 to 30 carbon atoms; an aryl group of 6 to 30 carbon atoms; or a heterocyclic group of 3 to 30 carbon atoms, and X is a chemical bond or an N, O or S atom, in case where X is O or S or a chemical bond R₈ is not present,
wherein in formula (3) R₉ is an alkylene group of 1 to 20 carbon atoms unsubstituted or substituted with a substituent, a cycloalkylene group of 5 to 20 carbon atoms unsubstituted or substituted with a substituent; or an arylene group of 6 to 20 carbon atoms unsubstituted or substituted with a substituent, wherein the substituent is an alkyl group of 1 to 10 carbon atoms, a cycloalkyl group of 5 to 10 carbon atoms, or an aryl group of 6 to 20 carbon atoms, and R₁₀ and R₁₁ are each independently an alkyl group of 1 to 30 carbon atoms; an alkenyl group of 2 to 30 carbon atoms; an alkynyl group of 2 to 30 carbon atoms; a heteroalkyl group of 1 to 30 carbon atoms; a heteroalkenyl group of 2 to 30 carbon atoms; a heteroalkynyl group of 2 to 30 carbon atoms; a cycloalkyl group of 5 to 30 carbon atoms; an aryl group of 6 to 30 carbon atoms; or a heterocyclic group of 3 to 30 carbon atoms.

3. The polymer according to claim 1 wherein in formula (1) R₄ is selected from groups according to formula (2) or (3) and wherein in formula (2):
R₅ is selected from the group consisting of a chemical bond or a linear or branched alkylene group of 1 to 20 carbon atoms, R₆ is an alkylene group —(CH₂)ₙ— where n is 2, 3 or 4 and wherein one or more than one but not all H atoms may be substituted by an alkyl group selected from C₁ to C₆ alkyls;
R₇ is an alkylene group —(CH₂)ₙ— where n is 2, 3 or 4 and wherein one or more than one but not all H atoms may be substituted by an alkyl group selected from C1 to C6 alkyls,
X is chemical bond linking R₆ and R₇ to form a ring structure,
R₈ is not present; and wherein
in formula (3):
R₉ represents chemical bond, an alkylene group —(CH₂)ₙ— where n is 1, 2, 3 or 4 and wherein one or more than one but not all H atoms may be substituted by an alkyl group selected from C1 to C6 alkyls;
R₁₀ represents a C₁ to C₃ alkyl, tri(C1-C3-)alkylsilyl;
R₁₁ represent independently from R₁₁ a C1 to C3 alkyl, tri(C1-C3-)alkylsilyl.

4. The polymer according to claim 1 comprising at least 50% by weight of units derived from the at least one conjugated diene.

5. The polymer according to claim 1 further comprising units derived units derived from a conjugated diene and further comprising units derived from at least one other conjugated diene, or at least one vinyl aromatic comonomer or combinations thereof.

6. The polymer according to claim 1 wherein the second functional group comprises, in addition to the group selected from —COOX, —OX and —SX groups, hydrogen atoms, from 1 to 150 carbon atoms and from 1 to 20 Si atoms and comprises at least one group selected from the formulae 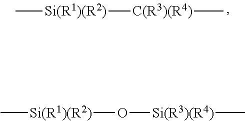
or a combination thereof, wherein R¹, R², R³, R⁴ are identical or different and are selected from H, and C₁-C₁₂ alkyl groups which, optionally, comprise heteroatoms selected from O, N, S, and Si, for example as alkoxy groups, trialkyl silyl groups, alkyl amino groups, dialkyl amino groups, trialkylsilyl amino groups and combinations thereof.

7. The polymer according to claim 1 wherein the second functional group, in addition to the group selected from —COOX, —OX and —SX, has from 1 to 150 carbon atoms and from 1 to 20 Si atoms and further comprises at least one group selected from the formulae 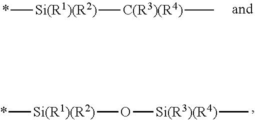
wherein R¹, R², R³, R⁴ are identical or different and are selected from H, and C₁-C₁₂ alkyl groups which, optionally, comprise heteroatoms selected from O, N, S, and Si, for example as alkoxy groups, trialkyl silyl groups, alkyl amino groups, dialkyl amino groups, trialkylsilyl amino groups and combinations thereof, wherein “*-” indicates a bond to the polymer chain.

8. The polymer according to claim 6 wherein the second functional group further comprises one or more heterogroups selected from (i) a thioether group, (ii) amino groups —N(R₁)—, —N(R₁)(R₂)— or —N(R₁)(R₂)(R₃), wherein R₁, R₂ and R₃ are independently selected from H, C₁-C₆ alkyl and —Si(C₁-C₆ alkyl)₃ with the proviso that not all of R₁, R₂ and R₃ represent H, (iii) ether groups —OR₄ or —OR₅—, wherein R₄ is a C₁-C₆ alkyl and R₅ is a C₁-C₆ alkylene, or a plurality or combination of such heterogroups.

9. The polymer according to claim 1 wherein the polymer is suitable for the manufacturing or molded articles.

10. A process of producing a polymer according to claim 1 comprising polymerizing at least one conjugated diene in a polymerization reaction to produce a diene polymer wherein either, (i) at least one functionalizing monomer, or an active reaction product comprising at least two repeating units derived from the functionalizing monomer, is added to the conjugated diene before, at the start of or during the polymerization reaction to create a functionalized polymer having at least one first functional group comprising at least one unit derived from the functionalizing monomer, or (ii) the polymerization is started by using an initiator of the of the general formula N(R₁)(R₂)(R₃M) as defined in claim 1, or a combination of (i) and (ii),
wherein the reaction further comprises adding at least one functionalizing agent to the functionalized diene polymer to create a second functional group, wherein the functionalizing monomer is represented by formula (1) 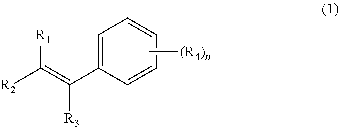
wherein R₁, R₂, R₃ are selected from hydrogen and methyl with the proviso that at least one of R₁, R₂ and R₃ is hydrogen,
n is 1, 2, 3, 4 or 5,
each R₄ is selected independently from an aliphatic, or aryl aliphatic residue having from 3 to 30 carbon atoms and wherein R₄ comprises at least one tertiary amine group if n is 1 and in case n is 2 to 5 at least one of the residues R₄ comprises at least one tertiary alkyl amine group; and
wherein the second functional group is a terminal group and comprises at least one group selected from —COOX; —OX; —SX, a plurality thereof or combinations thereof, wherein X represents hydrogen or a cation, and
wherein the conjugated diene is selected from the group consisting of butadiene, isoprene, isoprene, 1,3-pentadiene, 2,3-dimethylbutadiene, 1-phenyl-1,3-butadiene, 1,3-hexadiene.

11. A curable rubber compound comprising the polymer according to claim 1 and further comprising at least one curing agent capable of curing the polymer.

12. A rubber compound comprising the polymer according to claim 1 in a cured form.

13. A process of making a rubber compound comprising combining the polymer according to claim 1 with at least one curing agent capable of curing the polymer and, optionally, subjecting the polymer to curing.

14. A process of making an article comprising subjecting a rubber compound comprising the polymer according to claim 1 and at least one curing agent capable of curing the polymer to curing and shaping wherein the shaping may take place before, during or after the curing.

15. An article comprising a reaction product of a curing reaction of a composition comprising the polymer according to claim 1, wherein the article is selected from a tire, a tire tread, a shoe sole, a golf ball, a belt or a seal.
